(19) United States
(12) Patent Application Publication
(10) Pub. No.: US 2009/0041353 A1
(43) Pub. Date: Feb. 12, 2009

(54) Method and system for collecting event attendee information

(76) Inventors: Lewis Hoff, New York, NY (US); Hossein Kashani, Woodbury, NY (US); Ayman Ahmed, Yorktown Heights, NY (US)

Correspondence Address: Wyatt, Gerber & O'Rourke, LLP, 99 Park Avenue, New York, NY, 10016, US

(21) Appl. No.: 12/221,029

(22) Filed: Jul. 30, 2008

Related U.S. Application Data
(63) Continuation-in-part of application No. 11/540,295, filed on Sep. 29, 2006.

(51) Int. Cl. G06K 9/18

(52) U.S. Cl. 382/183

(57) ABSTRACT

A method and system for a user to collect point of contact information for one or more event attendees, in which identification information associated with an attendee is scanned and transmitted to a data server. More particularly, a method and system is provided for a user to scan a bar code on a visitor identification badge and extract an identification code which can be sent to a data server in order to obtain certain visitor information associated with the identification code. The user can access the data server to obtain the information associated with the user's data collection activity which can stored on the data server such as the information on each scanned visitor badge and associated visitor information, as well as time and location of the data capture.

### RELATED APPLICATIONS

This application is a continuation-in-part of application Ser. No. 11/540,295, filed Sep. 29, 2006, and titled “A Method and System for Collecting Sales Prospect Information” and is hereby incorporated by reference.

### FIELD OF THE INVENTION

The invention relates to data collection techniques in the field of exhibition industries. The invention is especially useful for one or more users to collect information while attending an event, such as trade exhibitions. More particularly, the invention provides a method using devices for users, such as exhibitors and event organizers, to capture and organize information obtained during contact with event visitors.

### BACKGROUND OF THE INVENTION

Present systems for collecting attendee information at exhibitions and other events include hand-held electronic devices for receiving and storing attendee and event information, such as from an identification tag. Information tags, such as event badges, are frequently created before an event or during registration and contain information related to a visitor, such as name, company and contact information. Such information can be encoded in bar codes and magnetic strips. Hand-held machines can be provided which are specifically designed for the information collection process in order to facilitate the collection of information contained in such badges. For example, a hand-held device can be provided with a magnetic strip reader for reading event and/or attendee information from a magnetic strip. In many circumstances, it is typically economically beneficial for users to rent the hand-held units from a supplier.

A problem with existing systems is that sensitive personal information can become disclosed to an unauthorized individual if the hand-held collection device is lost or stolen. Another problem with existing systems is that some users prefer to use information stored on their own personal mobile electronic devices, and prefer to carry only one device having several uses.

An additional problem posed by existing systems is the cost and logistics of shipping specially designed devices to and from users. A further problem is the cost of providing magnetic tags, or other such machine readable identification tags which are relatively difficult and costly to produce.

A solution offered by the invention is to utilize a generally ubiquitous information hand held capture device, namely mobile phones or other such devices having cameras and communication means, and to provide the hand-held devices with processes for capturing, decoding, storing, transmitting and receiving information such as that which may be contained in an information tag. A solution offered by the invention includes a process for extracting an identification code from a two dimensional bar code, which can be printed by generally available printing devices.

The processes can be embodied in whole or in part in computer readable code, such as software, and/or can be embodied in circuitry. A further problem is that computer readable code can be readily copied and distributed without benefit to the provider of the code and can be addressed by a solution according to the invention.

### OBJECT OF THE INVENTION

It is an object of the invention to provide an improved method and device for exhibitors to collect event attendee (i.e., visitor) information, such as an attendee's name, company affiliation, title, location, buying preferences and buying authority, and storing the collected information at a data server location for distributing collected information to users, such as exhibitors and event management.

It is a further object of the invention to reduce the reliance on the provider of identification tags to supply information, and to shift the reliance to a more flexible system. It is a further object of the invention to reduce the costs and logistics of shipping of component of systems to and from the location of an event.

Another object of the invention is to reduce the risk of maintaining and insuring physical hand held units. It is also an object of the invention to provide a method utilizing ubiquitous systems, such as mobile phones and PDAs.

In addition, it is an object of the invention to track data collection processes and user activity. It is a further object of the invention, to provide feedback information to information providers.

Another object of the invention is to provide an economic benefit to a system provider based on use of the hand-held devices, and more specifically on each instance of use. Another object of the invention is to provide an additional economic benefit to a system provider based on user activity reporting to information providers, among others.

Another object of the invention is to provide a system which prevents sensitive information from being disclosed if a collection device is lost or stolen.

### SUMMARY OF THE INVENTION

The invention relates to data collection techniques and devices which facilitate the collection and distribution of information from individuals at events, such as at trade exhibitions. The invention is especially useful for a user, such as an event exhibitor, to collect information from information tags, such as identification badges of event attendees who may visit an exhibitor, which identification badges can include bar coded identification information.

A method of collecting and disseminating certain visitor point of contact information regarding visitors of an event is provided wherein certain visitor information is provided for input into a data server. In addition, a bar code image of an identification tag is obtained with a hand held wireless data collector, and an identification code is extracted from the bar code image. The identification code can be sent to the data server, which the data server can store and use to lookup additional information associated with a particular visitor. The data server can send certain visitor information to the hand held wireless data collector, such as information which can be input to the data server at the time which a visitor registers for an event, based on the identification code, which information can be displayed by the hand held wireless data collector.

Specifically, the invention provides a system allowing a user to collect identification information from event attendees and facilitates the collection of other information associated with the user's collection of the event information, such as time and location of the collection activity. Furthermore, the invention provides a particular method of distributing information between user terminals and databases at at least one data server and facilitates the collection and distribution of visitor information collected at events, such as to exhibitors and event management by means of a web portal. In addition, the invention provides for a method and system for other event attendees, such as event exhibitors, to obtain information related to one or more users' collection activities, such as where an exhibitor collects information regarding an attendee, and vice versa.

The invention utilizes information tags, such as attendee badges which can be created before an event or during registration at an event. Preferably, the attendee badges include identification information such as name, contact information, and company information and also include coded information that is readable by devices adapted for use with the invention. For example, name, contact information, and company information can be encoded in a bar code or magnetic strip. In addition, or in the alternative, an identification code uniquely identifying an attendee can be encoded which can be used to identify a record of additional information associated with the attendee. Using the identification code, additional information about the visitor can be obtained from a hand held device or a data server. By using such a code, minimal information can be provided in the code thereby simplify the encoding necessary to identify the attendee as well as enhance the security of the information and protect the privacy of the attendee.

In one embodiment, a data collection device, such as a mobile phone or PDA, is provided that can allow a user to collect one or more event attendee's information. For example, a user such as an exhibitor can use a camera-equipped mobile phone to capture an image of a two-dimensional bar code on an identification tag, such as a badge that may be worn by an event attendee or that which may be provided at an event exhibit booth. The data collection device can decode the identification information provided on the identification tag, such as a visitor's badge, using known decoding techniques and can display the information. The data collection device can also transmit the scanned information to a data server which stores the scanned information along with information related to the data collection device, such as the identity of the device and associated user information. The data collection device can also transmit information related to the collection of the scanned information, such as time and location of the data collection event. A data server can be provided for receiving and storing information transmitted by data collection devices, and organize such information by exhibitor, by attendee and by user. Information on the data server can be accessed by a user through a web portal, such as an exhibitor who scanned one or more badges at an event.

In another embodiment of a device and method according to the invention a user, such as an event organizer or exhibitor, can communicate with the data server to obtain information related to the user's collection activities. For example, an exhibitor can use a system according to the invention to access a data server by means of an exhibitor terminal or web portal and request information concerning a particular badge scanned by the exhibitor, such as a name and contact information of the visitor. Typically, an exhibitor as a user can access a report on a web portal.

In another embodiment, the data server can permit a user to access the data server to obtain the information which other users scanned while attending an event. For example, an event manager can communicate with the data server by means of a user terminal or web portal, and request information related to one or more users, such as exhibitors at an event.

In another embodiment, the data server can require the exhibitor to pay for access to all or a portion of the information stored on the data server. In a further embodiment, the data server can require the exhibitor to pay for access to all or a portion of the information stored on the data server. In a further embodiment, the data server can require the event manager to pay for access to all or a portion of the information stored on the data server.

### BRIEF DESCRIPTION OF THE DRAWINGS

Preferred embodiments of the inventive devices are illustrated in the drawings and will be described below.

FIG. 1 illustrates a data collection device for collecting event attendee information according to the invention.

FIG. 2 illustrates a data collection device for collecting event attendee information according to the invention.

FIG. 3 illustrates a system for collecting event attendee information according to the invention.

FIG. 4 illustrates a method for collecting event attendee information.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION

A detailed description of the devices and methods for collecting event attendee information is provided below for general applicability. In addition, several specific embodiments are provided as examples of the devices and methods with which one of ordinary skill in the art may apply these teachings to address specific problems and to illustrate the benefits and improvements of the system and method over known solutions.

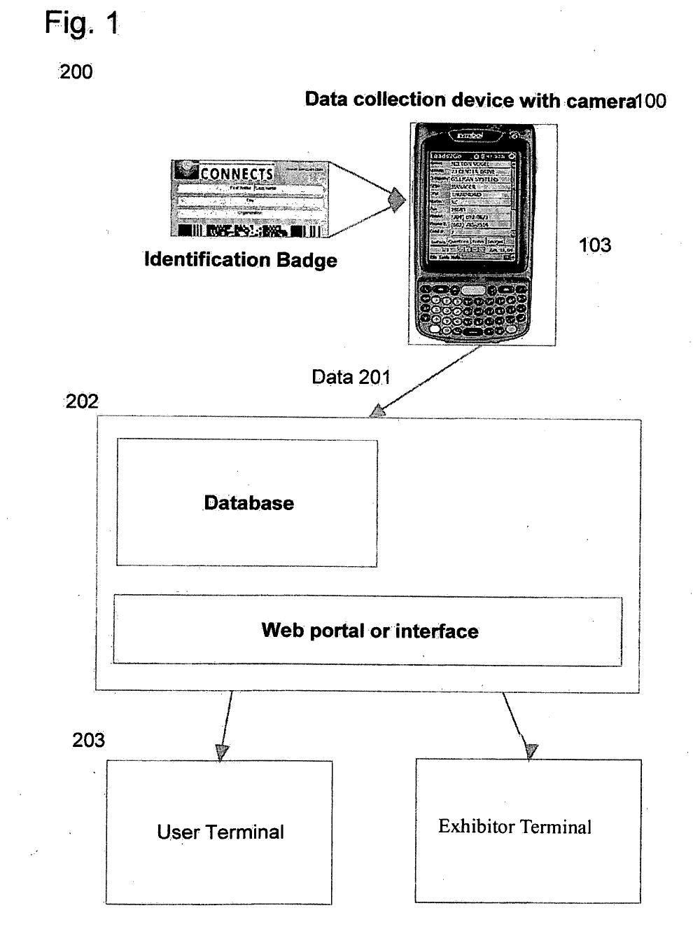

An embodiment of a system and method for collecting event attendee information 200 according to the invention is shown in FIG. 1. The system includes at least one hand held wireless data collector (referred to herein as data collection device 100) and at least one data server 202. For example, a data collection device 100 can be a mobile phone with a camera which can be used by an exhibitor to obtain an image of an identification tag of an event attendee. In one embodiment the data collection device 100 is adapted to take images of identification tags having a one and/or two dimensional bar code. After an identification tag is imaged or scanned by the device 100, the data collection device 100 can decode the image and extract certain visitor the information provided on the identification tag. For example, where the image includes a two dimensional bar code, the device 100 can decode the two dimensional bar code to extract the coded identification information, which can contain a complete visitor personal data file, or a subset of identification information, such as name and address, or simply an identification code which identifies or points to a record containing certain visitor information which can be encoded in a one-dimensional bar-code.

The data collection device 100 can send the identification information to the data server 202, or information can be sent in a batch after several images have been taken. Alternatively, the data collection device 100 can send the raw image date to the data server 200 for decoding. It can be appreciated that the data collection device 100 and data server 202 can be connected by a variety of communications means, such as wirelessly, and/or though one or more communications networks. For example, a mobile phone which has been adapted to perform the processes of the data collection device can send the image or decoded data by calling a data server 202 and sending the information through a phone network.

Each time identification information is sent to a data server 202, the data server can receive the information and process the received data for storage in a database. For example, information sent by a particular exhibitor using a data collection device 100 can be stored with other information sent by the exhibitor. As another example, information sent by a particular exhibitor using a data collection device 100 can be stored according to date, time and/or event for a number of exhibitors using data collection devices 100. In addition, a data server 202 can be provided with an interface, such as a network portal, for retrieving information stored by the server 202.

In addition, a system for collection event attendee information 200 can include one or more terminals, such as a user terminal 203 and/or an exhibitor terminal 204 for accessing information on a data server 202. It can be appreciated that the data server 202 can be connected to the user terminals 203 and exhibitor terminals 204 by a variety of communications means, such as wirelessly, and/or though one or more communications networks. For example, an exhibitor can use an exhibitor terminal 204 to access a web portal maintained by the data server 202 to obtain information that the exhibitor captured using a cell-phone adapted for use as a data collection device 100. The web portal can be password protected and can provide the exhibitor with information captured at a particular event, such as name, address and demographic information decoded from a event visitor's badge. In addition, or in the alternative, the system 200 can include a user terminal 203 for accessing information on a data server 202 in much the same way as the exhibitor terminal 204. In one embodiment, the web portal accessed by a user terminal 203 can be specifically adapted for different types of users, such as an event management individual, an exhibitor or attendee, to provide a different interface and provide different levels of access to information. For example, an event management individual can access a web portal to access information related to the data collection activities of one or more exhibitors, such as the number, location and frequency of the scanning activities of the exhibitors at an event associated with the event management individual.

Further details of the system 200 and its devices are provided herein.

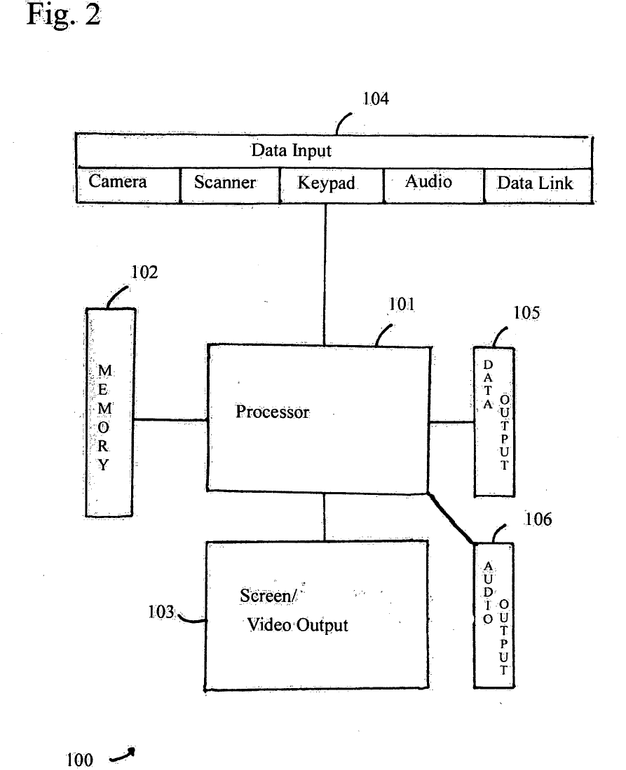

A data collection device 100 according to the invention can be used for collecting certain visitor information at a point of contact or event and is shown in FIG. 2. The data collection device 100 can be similar to that which is described in U.S. patent application Ser. No. 11/540,295, adapted however to include the functionality and processes described herein. For example, a mobile phone having an information capture device, such as a camera or bar code reader, and including programming and/or circuitry designed to perform the functions described herein can be used for a data collection device 100.

The data collection device can include a processor 101, a memory 102, a data input 104, and a data output 105. The device can also include a graphic display for video output 103 and an audio output 106. It can be appreciated that the processor 101, memory 102, and graphic display 103 can be programmed to provide the means for performing a number of the functions described herein, and for displaying the output results. It can be appreciated that other embodiments of the data collection device 100 can include small hand-held devices, as well as terminals and central servers which can be networked and designed or adapted for use with hand-held collection devices.

The processor 101 can be provided with programming embodying methods and processes according to the invention, and/or can be an integrated circuit used in conjunction with a memory 102. The memory can include at least portions of the programming that the processor executes. It can also be appreciated that a processor 101 can include an integrated circuit hardwired to perform one or more functions of the invention described herein.

A data input 104 can be provided for obtaining and storing collected information 302 on the data collection device 100. Preferably, the data input 104 includes a video input from a video source, such as a camera or scanner, and can provide an input port for data from a number of other sources. In addition, or in the alternative, data input 104 can include a keypad for receiving user commands and for manual input of information as well as an audio data source, and a data link among other things. Data can be transmitted to and received by the data input 104 by means of a variety transmission media, such as a hard-wired data link, and a radio frequency transmission link among other things. The data input 104 can comprise one or more ports on a device according to the invention. For example, a separate input port can be provided for audio information obtained by a data input including microphone. In addition, a separate data link port, or port to a separate bar code or RFID scanner can be provided. In an alternative embodiment of the invention, one or more input ports 104 can be provided, and these ports can be connected to an additional device which can receive and combine information from one or more input ports to provide a single input port for communication with a single input source.

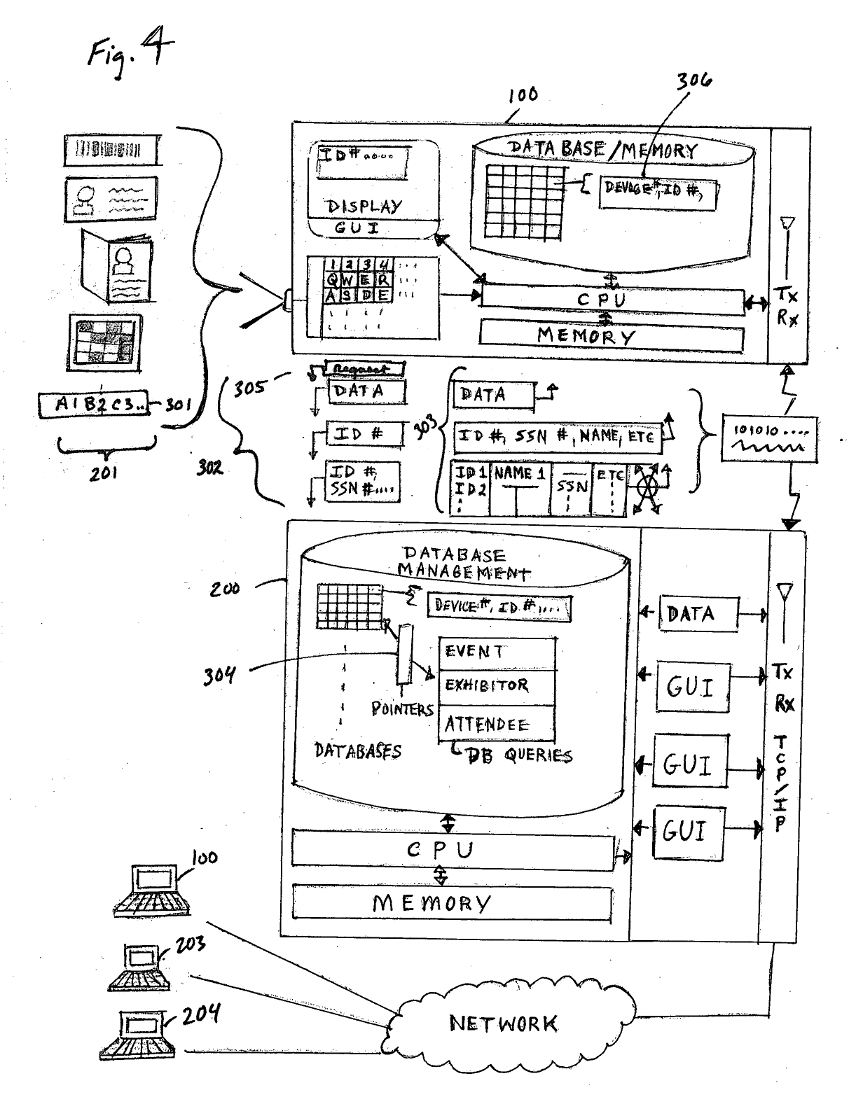

As shown in FIG. 4, data can also be input into a data collection device 100 by other methods, such as by keying the data through a keypad, or data can be transmitted electronically to the hand-held unit by another device, such as a registration terminal 203 or another hand-held unit 100. For example, attendee and event information can also be downloaded to a data collection device 100 from other hand-held devices 100, from a terminal 203 or form a server 202 containing attendee and event information.

A data collection device 100 according to the invention can be specifically designed for use with specific forms of visitor identification information 201, such as information badges having computer readable images such as bar codes as well as driver's licenses. Preferably, the device and method are specifically adapted for use with a particular identification tag, such as a two-dimensional bar code that is readable only data collection devices 100 that have been appropriately adapted, such as for a particular event. It can be appreciated, however, that a data collection device 100 can be adapted to receive information from other information sources.

Visitor information stored on the device 100 can be output for viewing by a user on the display 103. For example, the display 103 can show a list of records, information contained in one or more records, as well as image information captured as observation information. It can be appreciated that data collection device can be provided with programming which enables the display 103 to display one or more pages of information associated with one or more records, which a user can access such as by selecting a tab of a graphical user interface (GUI) associated with a page of information. It can be appreciated that the device 100 can be adapted to retrieve stored information in a number of ways, such as by programming to provide a search form or index. In addition, the display 103 can be provided with a graphical user interface for receiving user commands, such as capture, view and send information. The data collection device 100 can be programmed to display all or part of the visitor identification information 201 to a user such as upon scanning of information by the user, or upon recall by the user of previously stored information.

A data collection device 100 according the invention can be adapted to perform processes for collecting and storing information including identification information 201, and transmitting and receiving information to and from a data server 202, such as shown in FIGS. 2 and 4. Processes provided by the data collection device 100 are also shown in FIG. 4.

As used here, certain visitor identification information 201 includes information which identifies an individual, such as name, address, and other contact information, but can also include other associated information such as corporate affiliation, information related to the corporate affiliation, title, buying preferences, buying authority, and information related to an event, such as time, location and name of an event, among other things. The information can be provided on an identification tag and can include information pertinent to an event, individual and/or exhibit. For example, information 201 on an identification badge can include personal identification information, and other information related to an individual. Alternatively, or in addition, products, services and/or corporate information can be provided. In addition, or in the alternative, demographic information or location information of an event, among other things can be provided.

In a preferred embodiment, visitor identification information 201 includes an identification code 301, such as a numeric code, index or pointer to identify a visitor and/or their identification information 201. For example, associated visitor identification information 304 can be input during and/or before an event and can be stored on a server and associated with a code 301 identifying the records containing that visitor information. Accordingly, an identification badge or tag can be provided to contain simply the identification code 301 which a device can user to obtain associated visitor identification information 304.

The data collection device 100 can be provided with a memory 201 for storing the identification information 201. It can be appreciated that the data collection device 100 and data server 202 can store data 201 in a variety of ways, such as in a database maintained by programmed computer code. It can be appreciated that the information can be stored in memory such as an integrated circuitry chip, hard drive, removable memory such as floppy disk, USB memory stick, a memory card or secure data card and/or a remote unit's battery-backed memory among other things.

Preferably the data collection device is adapted to obtain data input from digital sources, such as two dimensional bar codes. For example, the data collection device 100 can capture an image of an identification tag and store at least a portion of the identification tag in memory. Once the image is captured, it can be processed by the data collection device 100 to extract and store information contained in the identification tag, such as attendee and event information. In an embodiment where information is captured from an image or scan, preferably the information is stored in a record that is uniquely identified to the image or scan. Alternatively, the scanned information can be transmitted as raw image data to a data server 202 or other device for processing and extraction of encoded information. It can be appreciated that information can be encoded in a number of ways, including one or two-dimensional bar codes.

Preferably, the data collection device 100 extracts a portion of the identification information 201 available on an information tag, such as an identification code. In addition, or in the alternative, the data collection device 100 can obtain a selection of visitor identification information 201 provided in the identification tag, such as name and phone number, as well as an identification code. Once the code is extracted, one or more records associated with the identification code can be obtained. For example, the data collection device 100 can obtain additional visitor information 201 from the data server 202 using the code.

A data collection device 100 can obtain one or more records associated with the identification information 201. For example, where the visitor identification information 201 includes an identification code 302, the data collection device can obtain from memory information associated with the identification code 302 or though other lookup terms, such as visitor name. Alternatively, or in addition, the data collection device 100 can send a data request to a data server or other device requesting visitor information associated with a code or other lookup term.

Preferably, the data collection device 100 obtained the visitor information from external sources, such as from a database maintained by a data server 202 or from the memory of another data collection device 100. For example, an exhibitor at an event can take a photo of an attendee's identification badge using a hand held device 100 designed for data collection, and after extracting an identification code from the image, the device 100 can then look up a record corresponding to the identification code. The record can include information, such as name and address of the attendee, which can then be displayed on the device 100.

Preferably, each data collection device 100 is provided with at least one device identification code 306 to identify each device which can be sent to the data server. In addition, as a device scans badges and obtains information, data collection device activity information can be obtains, such as time of the scan and location of the device, which can also be transmitted as part of the collection information 302 sent to a server.

The data collection device 100 can send visitor information 201 as collected information to one or more devices on a system according to the invention. In addition or in the alternative, the data collection device 100 can send one or more data requests 305 to one or more devices. A device 100 can send a data request 305 to obtain from a server data updates and/or additional visitor information associated with an identification code 301 or identification information 201.

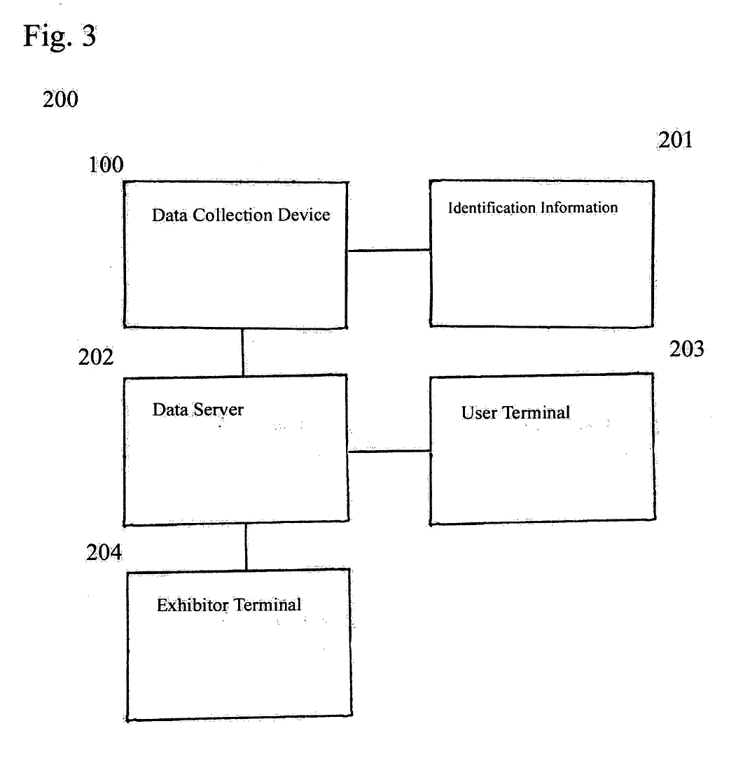

As shown in FIG. 3, a system 200 for collecting event attendee information according to the invention is described herein, and includes at least one data collection device 100 and at least one data server 202. In addition, the system 200 can include one or more user terminals 203, and one or more exhibitor terminals 204. The system can include, or be designed for use with visitor information 201, such as an exhibitor tag or an attendee identification tag.

The components of the system 200, such as the data collection devices 100, data servers 202, user terminals 203 and exhibitor terminals 204, can be comprised of devices, such as computers and other electronic devices for operating programmed computer code or specifically designed machines, embodying the processes and functionality described herein. It can be appreciated by one of ordinary skill in the art that the components of the system 200 can be operatively connected to communicate in a number of ways, including, electronically, wirelessly and can include intervening networked electronic communication networks between components of the system.

A data server 202 is provided, such as a computer having a transmitter, receiver, CPU and memory for receiving, transmitting, and storing information such as identification information 201 from one or more components of the system including one or more data collection devices 100, data servers 202 and user terminals 203. The data server 202 can receive information from a user terminal 203 and preferably stores the information in a database, which can be maintained by the data server 202. For example, identification information 201 can be sent to the data server 202 by a user terminal 203, such as when an attendee registers for an event. In addition, a data server 202 can receive information, such as visitor information collected by a device 100 (i.e., collected information 302), data requests 305 and identification codes 301 from one or more data collection devices 100.

Preferably, the data server 202 stores this received information with at least one server identification code 304, such as index or pointer information 304, to facilitate the retrieval of one or more portions of the identification information 201 stored by the server. Server identification codes 304 stored by the server can also include information to identify lists or groups of information which may satisfy one or more search criteria which can be provided by the server for users, such as exhibitors, to search for data through a web portal.

The data server 202 can transmit at least a portion of the event and attendee information stored in the database to one or more data collection devices 100. In one embodiment, the data server 202 transmits only a portion of the event and attendee information to each of the data collection devices 100. For example, the data server 202 can send a portion of a database comprising one or more records including identification information 201 to a data collection device 100, such as name and phone number associated with one or more identification codes. The data server 202 can transmit such a batch of information to a data collection device 100 when the data collection device 100 is being initialized for use. The data server 202 can also transmit such a batch of information to a data collection device 100 when the data collection device 100 requests information associated with one or more identification codes, or when information on the data server 202 is changed, or when the data server 202 is instructed to send updated information to one or more data collection devices 100.

Alternatively, or in addition, the data server 202 can send only additional identification information in a record associated with an identification code to a data collection device 100. For example, a data collection device 100 can be provided with limited identification information 201 associated with an identification code, and the data collection device 100 can request additional identification information from the data server 202. Such a method can be useful to facilitate the updating of information stored on each of the data collection devices 100, for example, by limiting the scope of information that is transmitted at an update event by the data server 202. For example, the data server 202 can be programmed to collect information and prepare a queue including a series of records to be sent to specific devices 100 which may request one or more updated records, or which can be broadcast, or multicast to a number of devices 100.

A user terminal 203 and an exhibitor terminal 204 can be provided for sending information to the data server 202, including visitor identification information 201. Information 201 can include event and attendee information, such as when an attendee or an exhibitor registers for an event. Additional information can be provided beyond that which may be on an information badge, and can include visitor identification information such as name, address, and other contact information, as well as corporate affiliation, information related to the corporate affiliation, among other things. In addition, the user terminal 203 and exhibitor terminal 204 can be programmed to request and receive information 201 from the data server 202.

For example, an exhibitor or the exhibitor terminal 204 can access a web portal maintained by a data server 202 and request information scanned by the exhibitor. As a second example, at the conclusion of an event, an exhibitor may have been visited by a number of event attendees, and those event attendees may have used one or more data collection devices 100 to scan an exhibitor's badge 204. Accordingly, the data server 202 can be programmed to receive information from those data collection devices 100 and can store information related to the activities of those attendees who visited a particular exhibitor, such as time of visit, and the identification information of the user associated with the particular data collection device 100 which scanned the exhibitors badge.

In another embodiment of the invention, network accessibility can be provided such as through a transmitter/receiver for communicating information among one or more data collection devices 100, data servers 202 and user terminals 203. In addition, the data collection device can be operatively connected to a user terminal 203 and/or an exhibitor terminal 204. In another embodiment, information can be captured by hand-held devices according to the invention and uploaded to an on-line database for access through a web portal maintained by a server. In addition, lead information can be exported from a network address, such as an Internet website, to a database format, such as a CSV or Excel file format which can be read by applications such as Microsoft Excel, and can thereby be viewed remotely on hand-held contact collection devices 100 or other operatively connected devices in the system 200.

A system 200 according to the invention can be programmed to give users access to a database containing records of visitor information 201 and other information, such as through a user terminal 203 or an exhibitor terminal 204. The system 200 can include a web portal for users to edit, or add data, and/or to provide reports and customizable search queries to obtain one or more records, or portions of records. The visitor data captured by users can be automatically generate added to customized reports and can be integrated with other systems, such as case management systems.

In another embodiment, a device and system according to the invention can be provided for tracking and analyzing the collection activity of one or more data collection devices 100. For example, a number of exhibitors may scan information badges from a number of visitors throughout an event. Event organizers can use an exhibitor terminal to access data on the data server which can provide data collection device activity information such as the time and locations at which data has been collected by users of devices 100 at an event.

The invention has been described in connection with certain preferred embodiments. It will be appreciated that those skilled in the art can modify such embodiments without departing from the scope and spirit of the invention that is set forth in the appended claims. Accordingly, these descriptions are to be construed as illustrative only and are for the purpose of enabling those skilled in the art with the knowledge needed for carrying out the best mode of the invention. The exclusive use of all modifications and equivalents are reserved as covered by the present description and are felt to be within the scope of the appended claims.

For example, the invention has been described in terms of events, users, exhibitors and exhibitions. However, it can be appreciated that the invention can be adapted for use in other situations, for other individuals, entities and groups.

We claim:

1. A method of collecting and disseminating certain visitor point of contact information regarding visitors of an event, comprising:
providing certain visitor information for input into a data server,
obtaining a bar code image of an identification tag with a hand held wireless data collector;
extracting an identification code from the bar code image;
sending the identification code to said data server; and
transferring said certain visitor information from said data server to said hand held wireless data collector based on said identification code for display by said hand held wireless data collector.

2. A method according to claim 1, further comprising the step of providing a visitor with an identification tag having a bar code.

3. A method according to claim 1, wherein said certain visitor information includes information selected from the group comprising visitor identification information, demographic information, qualification information, and an identification code.

4. A method according to claim 1, wherein the step of extracting the identification code from the bar code image is performed by said hand held wireless data collector.

5. The method according to claim 1, further comprising the step of receiving visitor information at a user terminal, and transmitting at least a portion of the visitor information from the user terminal to said hand held wireless data collector.

6. The method according to claim 1, further comprising the step of receiving visitor information at an exhibitor terminal, and transmitting at least a portion of the visitor information from the exhibitor terminal to said hand held wireless data collector.

7. The method according to claim 1, further comprising the step of transmitting data collection device activity information from said hand held wireless data collector to said data server, wherein the data collector device activity information includes time and location of said step of obtaining a bar code image.

8. The method according to claim 1, wherein the step of obtaining a bar code image includes obtaining raw image information; and further comprising the step of transmitting the raw image information to said data server; and wherein said step of extracting an identification code from the bar code image is performed by said data server.

9. A method of collecting and disseminating certain visitor point of contact information regarding visitors of an event, comprising:
obtaining a bar code image of an identification tag with a hand held wireless data collector;
extracting an identification code from the bar code image;
sending the identification code and data collection device activity information to said data server; and
transmitting certain visitor information from a data server to said hand held wireless data collector, wherein said certain visitor information is associated with said identification code.

10. A method according to claim 9, further comprising the steps of
providing a visitor with an identification tag having a bar code; and providing said certain visitor information and data collection device activity information to a user through a web portal.

11. A hand held wireless data collector for collecting point of contact information comprising:
a data input, a processor, a memory, a display, a transmitter, and a receiver; wherein the data input includes a camera for receiving visual information, and wherein the processor comprises programming to extract an identification code from the visual information, to store the identification code in memory, to transmit said identification code to a data server, and to receive control commands from the data input.

12. The device according to claim 11, wherein the visual information includes bar code information and wherein the programming to extract an identification code is programming to extract an identification code from a bar code.

13. The device according to claim 12, wherein the bar code is a two-dimensional bar code.

14. The device according to claim 12, wherein the processor further comprises programming to receive certain visitor information from the data server and to associate said certain visitor information with said identification code.

15. The device according to claim 14, wherein the processor comprises programming to transmit data collection device activity information to said data server, wherein the data collector device activity information includes time and location information.

16. The device according to claim 13, wherein the processor further comprises programming to receive update information from the data server, therein said update information includes certain visitor information.

17. A data server for use with at least one data collection device for collecting point of contact information comprising:
at least one data server comprising a data input, a processor, a memory, a user input, a display, a transmitter, and a receiver; wherein the data server processor comprises programming to receive and store certain visitor information, to receive an identification code from a hand held wireless data collector;
at least a portion of said certain visitor information to said hand held wireless data collector, wherein said certain visitor information is associated with said identification code, and to provide at least a portion of said certain visitor information to a user through a web portal.
